(19) United States
(12) Patent Application Publication
(10) Pub. No.: US 2005/0035716 A1
(43) Pub. Date: Feb. 17, 2005

(54) Electrodeless lamp

(75) Inventor: Kyung-Hoon Park, Gumi (KR)

Correspondence Address: OSTROLENK FABER GERB & SOFFEN, 1180 AVENUE OF THE AMERICAS, NEW YORK, NY, 100368403, US

(73) Assignee: LG ELECTRONICS INC.

(21) Appl. No.: 10/754,767

(22) Filed: Jan. 8, 2004

(30) Foreign Application Priority Data
Aug. 13, 2003 (KR) 56135/2003

(51) Int. Cl. H01J 17/16; H01J 61/30

(52) U.S. Cl. 313/634; 313/153; 313/493; 313/161

(57) ABSTRACT

Disclosed is an electrodeless lamp, by which the even distribution of the plasma generated by the electromagnetic energy is provided to induce the even radiation of the light by the emitting plasma, thereby enhancing the illumination effect. Moreover, the present invention shortens both of the initial lighting time and the relighting time, thereby enhancing user's convenience as well as product reliance. The present invention includes a transparent bulb portion forming a filling space inside to be charged with a gas-fill generating plasma by electromagnetic energy, a stem portion extending from the bulb portion to a predetermined length to become a rotational shaft of the bulb portion, and a protruding portion protruding from an inner circumference of the bulb portion.

### BACKGROUND OF THE INVENTION

1. Field of the Invention

The present invention relates to a plasma lighting system, and more particularly, to an electrodeless lamp, by which distribution of plasma emitting light by electromagnetic wave energy is equalized and reemission time is minimized.

2. Description of the Conventional Art Generally, a plasma lighting system excites gas charged in an electrodeless lamp to transform into a plasma phase, whereby surroundings are illuminated by light emitted from the plasma. The light emitted from the plasma is a natural light having an illumination effect superior to that of a glow or fluorescent light. And, the electrodeless lamp has a relatively long endurance.

FIG. 1 is a cross-sectional view of a plasma lighting system according to a related art.

Referring to FIG. 1, a plasma lighting system according to a related art consists of a casing 10, a high voltage generating means 20 loaded within the casing 10 to generate high voltage, a magnetron 30 loaded in the casing 10 to transform the high voltage of the high voltage generating means 20 into an electromagnetic wave, a waveguide 40 guiding the electromagnetic wave generated from the magnetron 30, a resonator 50 installed outside of a front side of the casing 10 to generate an intensive electric field by exciting the electromagnetic wave guided by the waveguide 40, an electrodeless lamp 60 rotatably loaded within the resonator 50 and charged with a filling material to generate a plasma light by having the filling material excited by the intensive electric field of the resonator 50, and a mirror 70 and a reflector 71 provided in rear of the electrodeless lamp 60 to reflect the light emitted from the electrodeless lamp 60 in a front direction.

A first drive motor 80 is installed within the casing 10 to rotate the electrodeless lamp 60, and a shaft 81 of the first drive motor 80 is connected to the electrodeless lamp 60.

An air duct 11 is provided to one side of the casing 10, a fan 90 for sucking external air is installed inside the air duct 11, and a second drive motor 100 is installed in the vicinity of the fan 90 to rotate the fan 90.

An operation of the above-constructed plasma lighting system is explained as follows.

First of all, once power is applied to the plasma lighting system, the high voltage generating means 20 generates the high voltage. The magnetron 30 then oscillates the electromagnetic wave. The electromagnetic wave oscillated from the magnetron 30 is transferred to the resonator 50 via the waveguide 40 to distribute the intensive electric field inside the resonator 50. The filing material charged in the electrodeless lamp 60 is discharged by the intensive electric field distributed in the resonator 50 to be vaporized into plasma. The light emitted from the plasma generated from the electrodeless lamp 60 is reflected on the mirror 70 and reflector 71 in the front direction.

The first drive motor 80 is driven to rotate the electrodeless lamp 60 and the second drive motor 100 is driven to rotate the fan 90. As the fan 90 rotates, the external air flows in the casing 10 via the air duct 11 to cool down the high voltage generating means 20 and the magnetron 30.

Meanwhile, the electrodeless lamp 60, as shown in FIG. 2, consists of a bulb portion 62 formed of a transparent material having a spherical figure to provide a filling space 61 inside, a stem portion 63 extending from one side of the bulb portion 62 to a predetermined length to be connected to the shaft of the first drive motor 80, and a gas-fill charged in the filling space 61 of the bulb portion 62. The bulb portion 62 is formed like a sphere having a predetermined thickness and the stem portion 63 has a round rod figure having a predetermined length.

As the gas-fill in the filling space 61 is excited by the electric field appearing inside the resonator 50, the electrodeless lamp 60 generates the plasma emitting light. In this case, the discharge starts from a portion inside the resonator 50 where the electric field over a predetermined level is formed, whereby the plasma is concentrated on a portion of the filling space 61 of the electrodeless lamp 60. Yet, in order to prevent the plasma from being concentrated on the portion of the filling space 61 of the electrodeless lamp 60 and to equalize the distribution of the plasma, the first drive motor 80 rotates the electrodeless lamp 60.

Moreover, the gas-fill of the electrodeless lamp 60 is transformed into the plasma by the electric field, i.e., electromagnetic energy, to generate heat. In this case, the electrodeless lamp 60 rotates to prevent the bulb portion 62 of the electrodeless lamp 60 from being intensively heated by the heat of the plasma.

Even though the above-constructed electrodeless lamp 60 is rotated by the driven first drive motor 80 to prevent the concentration of the plasma as well as the intensive heating of the bulb portion 62, the plasma in the filling space 61, as shown in FIG. 3, makes an oval figure centering on a rotational axis by the rotation of the electrodeless lamp 60 to fail to provide uniform light of the plasma.

Moreover, there are various kinds of the gas-fill charging the filling space 61 of the bulb portion 62 according to their properties, and the compositions of the gas-fills are widely known.

Each of the various kinds of the gas-fills for the electrodeless lamp 60 takes a predetermined time (several tens of seconds to several minutes) for relighting after putting-out-light. This is because a mean free path of an electron having energy necessary for plasma discharge fails to be sufficiently secured, as a pressure of neutral gas in the filling space 61 of the electrodeless lamp 60 is too high.

In order to reduce the time taken for the relighting, a strong wind is directly blown to the electrodeless lamp 60 to cool down so that the pressure in the electrodeless lamp 60 is lowered. Yet, such a method needs a separate blower to increase product costs.

### SUMMARY OF THE INVENTION

Accordingly, the present invention is directed to an electrodeless lamp that substantially obviates one or more problems due to limitations and disadvantages of the related art.

An object of the present invention is to provide an electrodeless lamp, by which distribution of plasma emitting light by electromagnetic wave energy is equalized.

Another object of the present invention is to provide an electrodeless lamp, by which reemission time is minimized.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an electrodeless lamp according to the present invention includes a transparent bulb portion forming a filling space inside to be charged with a gas-fill generating plasma by electromagnetic energy, a stem portion extending from the bulb portion to a predetermined length to become a rotational shaft of the bulb portion, and a protruding portion protruding from an inner circumference of the bulb portion.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a plasma lighting system according to a related art;

FIG. 2 is a front view of a plasma lighting system according to a related art, in which a cross-sectional view of an electrodeless lamp is partially shown;

FIG. 3 is a front view of an operating electrodeless lamp according to a related art;

FIG. 4 is a cross-sectional view of a plasma lighting system according to one embodiment of the present invention;

FIG. 5 is a front view of a plasma lighting system according to the present invention, in which a cross-sectional view of an electrodeless lamp is partially shown; and

FIGS. 6 to 8 are front views of an electrodeless lamp according to another embodiments of the present invention, in which cross-sectional views of an electrodeless lamp are partially shown, respectively.

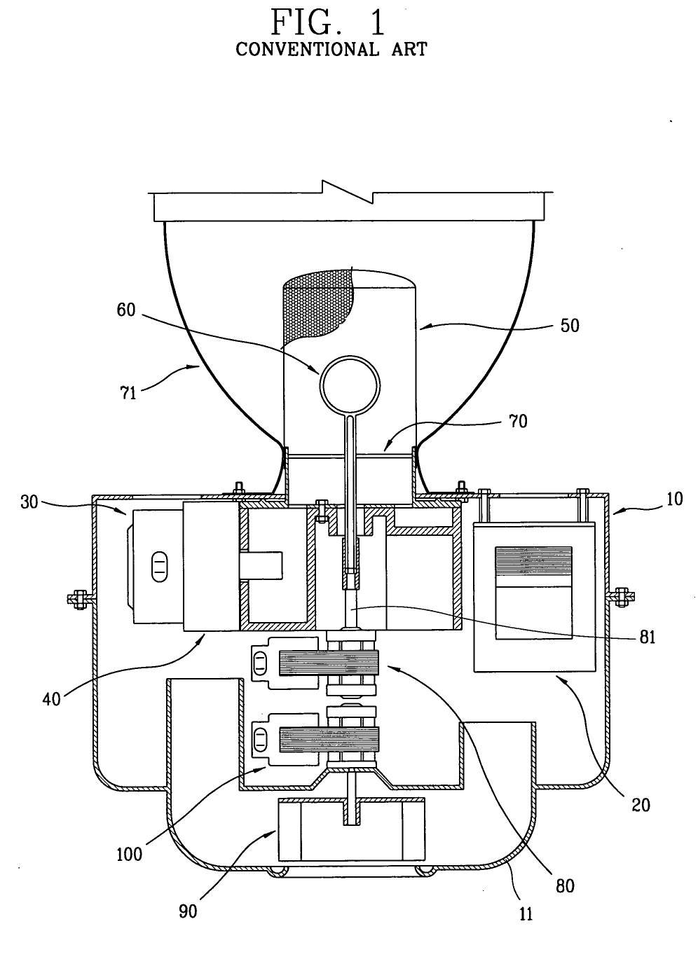

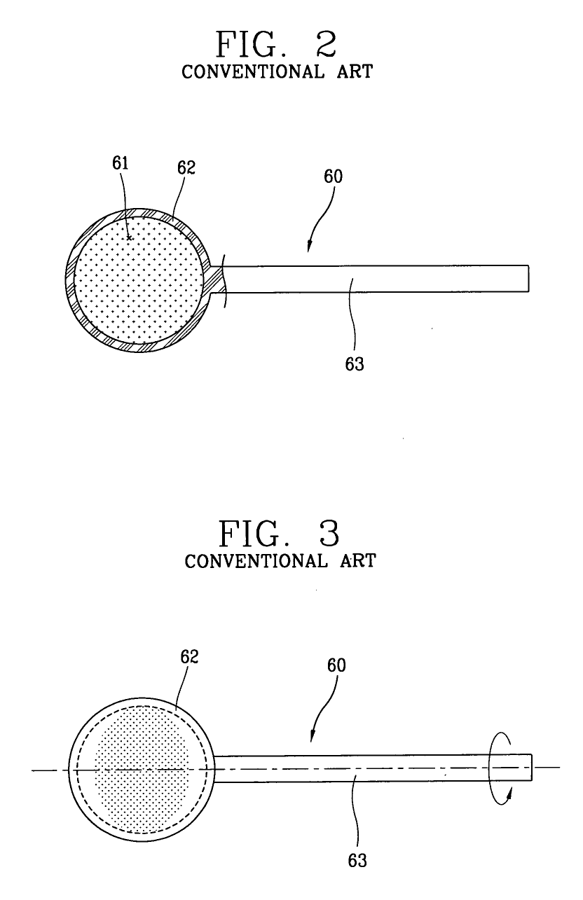

### DETAILED DESCRIPTION OF THE INVENTION

Reference will now be made in detail to the preferred embodiments of the present invention, examples of which are illustrated in the accompanying drawings.

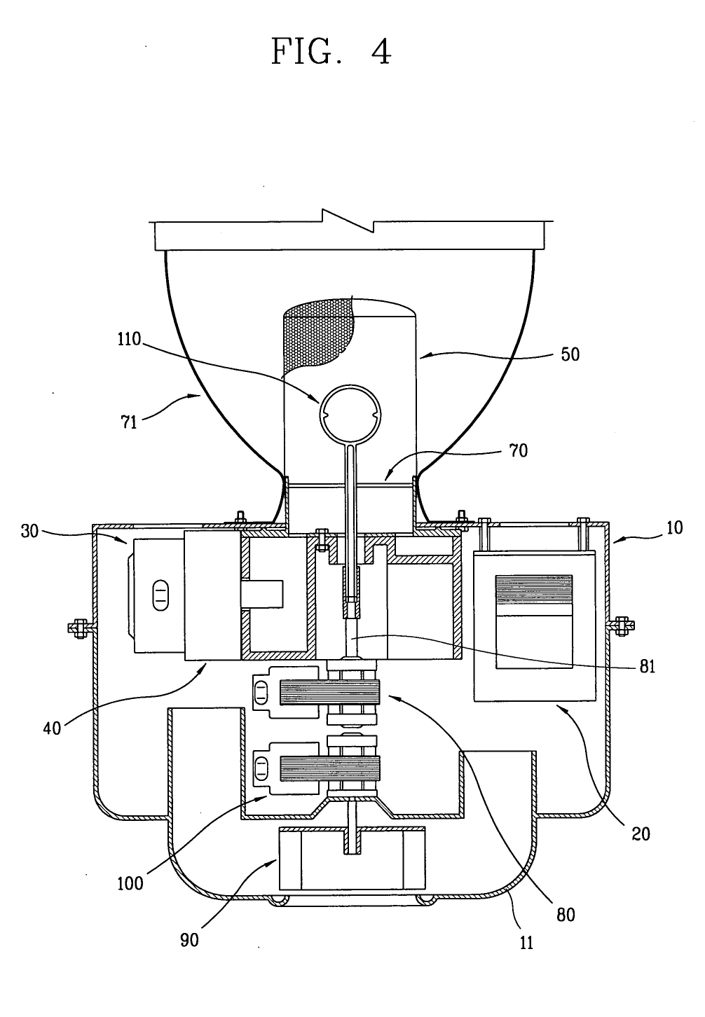

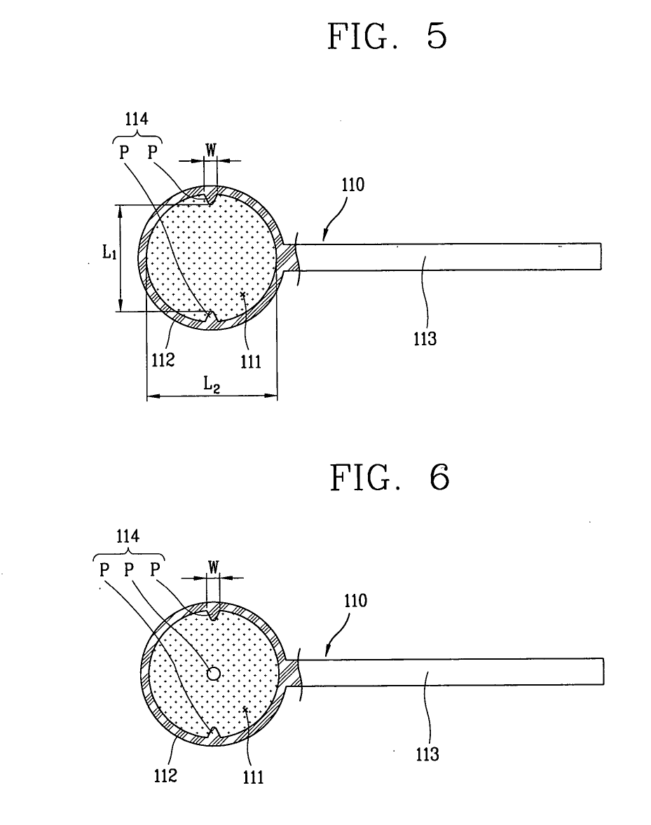

FIG. 4 is a cross-sectional view of a plasma lighting system according to one embodiment of the present invention and FIG. 5 is a front view of a plasma lighting system according to the present invention, in which a cross-sectional view of an electrodeless lamp is partially shown. In the drawings, like elements are indicated using the same reference designations where possible.

As shown in the drawings, a construction of the plasma lighting system according to the present invention is like that of the related art, whereby the detailed explanation of the construction of the present invention is skipped in the following description.

In the plasma lighting system, an electrodeless lamp 110 according to the present invention is rotatably installed within a resonator 50 to be connected to a first drive motor 80. Besides, the electrodeless lamp 110 can be connected to a shaft 81 of the first drive motor 80 through a separate connecting means or can be directly connected to the shaft 81 of the first drive motor 80.

The electrodeless lamp 110 according to the present invention, as shown in FIG. 5, includes a transparent bulb portion 112 forming a filling space 111 inside to be charged with a gas-fill generating plasma by electromagnetic energy, a stem portion 113 extending from the bulb portion 112 to a predetermined length to become a rotational shaft of the bulb portion 112, and a protruding portion 114 protruding from an inner circumference of the bulb portion 112.

The bulb portion 112 has a spherical figure and is uniform in thickness.

The protruding portion 114 includes a pair of protrusions P protruding from the inner circumference of the bulb portion 112. The protrusions P are formed of the same material of the bulb portion 112 to extend from the inner circumference of the bulb portion 112.

A pair of the protrusions P are vertical to an axis extending from the same axis of the stem portion 113 and lie in the same line on the inner circumference having the greatest diameter of the bulb portion 112 to confront each other.

A ratio L1/L2 of a length L1 between ends of the protrusions P over an inside diameter L2 of the bulb portion 112 is 1/1.3.

Each cross-section of the protrusions P is circular, and each width W, i.e., each inside diameter, of the protrusions P is L2/8˜L2/6 for the inside diameter L2 of the bulb portion 112.

Each cross-section of the protrusions P can have various figures such as a quadrangle and the like, and the protrusions P may be formed of a material different from that of the bulb portion 112.

In an electrodeless lamp according to another embodiment of the present invention, as shown in FIG. 6, a protruding portion 114 includes at least two protrusions P formed on an inner circumference of the bulb portion 112.

The at least two protrusions P are vertical to an axis extending from the same axis of the stem portion 113 and lie on the inner circumference having the greatest diameter of the bulb portion 112. The at least two protrusions P are provided by pairs, and each pair of the protrusions P lie in the same line to confront each other.

The protrusions P are formed of the same material of the bulb portion 112, and may have the same height or differ in height.

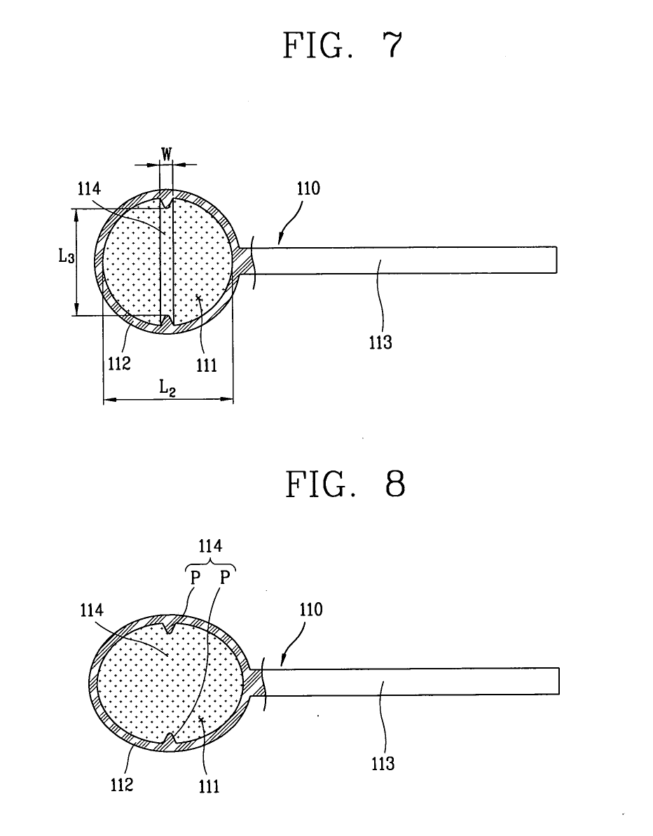

In an electrodeless lamp according to a further embodiment of the present invention, as shown in FIG. 7, a protruding portion 114 is formed like a ring type to protrude from an inner circumference of the bulb portion 112 with uniform width and height.

The ring type protruding portion 114 is vertical to an axis extending from the same axis of the stem portion 113 and lies on the inner circumference having the greatest diameter of the bulb portion 112.

A width of the ring type protruding portion 114 is L2/8˜L2/6 for the inside diameter L2 of the bulb portion 112.

And, a ratio L3/L2 between an inside diameter L3 of the ring type protruding portion 114 and the inside diameter of the bulb portion 112 is 1/1.3.

In an electrodeless lamp according to another further embodiment of the present invention, as shown in FIG. 8, a bulb portion 112 is formed oval. A long axis of the oval bulb portion 112 lies in the same line of the stem portion 113.

A protruding portion 114 is formed on an inner circumference of the bulb portion 112. The protruding portion 114 includes a pair of protrusions P formed on the inner circumference of the bulb portion 112. A pair of the protrusions P lies in a direction of a short axis of the oval bulb portion 112. Namely, a pair of the protrusions P lie in a vertical direction to an axis extending from the same axis of the stem portion 113 to confront each other on a straight line.

Meanwhile, the protruding portion 114 can have various figures. For instance, the protruding portion 114 may include a plurality of protrusions P lying on the short axis of the oval bulb portion 112. Preferably, a plurality of the protrusions P are provided by pairs.

For another instance, the protruding portion 114 may have a circular ring shape that is uniform in thickness and height.

An operation of the electrodeless lamp according to the present invention is explained as follows.

First of all, once power is applied to the plasma lighting system, the high voltage generating means 20 generates the high voltage so that the magnetron then oscillates the electromagnetic wave.

The electromagnetic wave oscillated from the magnetron 30 is transferred to the resonator 50 via the waveguide 40 to distribute the intensive electric field inside the resonator 50.

The filing material charged in the electrodeless lamp 110 is discharged by the intensive electric field distributed in the resonator 50 to be vaporized into plasma. In this case, the most intensive electric field is formed at a center of the bulb portion 112 of the electrodeless lamp so that the plasma is generated from the center of the bulb portion 112 to radiate heat.

The first drive motor 80 is driven to rotate the electrodeless lamp 110. As the electrodeless lamp 110 rotates to evenly distribute the plasma in the filling space 111, light is evenly emitted as well as the heat of the plasma is inhibited from being concentrated on the bulb portion 112.

Moreover, in distributing the plasma evenly in the electrodeless lamp 110 that is rotating, a centrifugal force generated from the rotation of the electrodeless lamp 110 makes the plasma fail to form a perfect sphere. Instead, the plasma intends to form an oval figure inclining to a vertical direction to a rotational axis. In this case, the protruding portion 114 provided in the bulb portion 112 of the electrodeless lamp 110 helps the plasma forming a spherical figure in the filing space 111 of the bulb portion 112 and evenly induces the emission of light.

Thus, the light emitted from the electrodeless lamp 110 is reflected on the mirror 70 and reflector 71 in the front direction.

Moreover, in case of relighting after putting-out-light, the protruding portion 114 protruding from the inner circumference of the bulb portion 112 of the electrodeless lamp 110 plays a role as an electrode to accelerate the cooling of the gas-fill in the filling space 111 of the bulb portion, thereby reducing the reemission time of the plasma. Besides, in case of initial lighting, the protruding portion 114 playing a role as the electrode shortens an initial lighting time as well.

Accordingly, the electrodeless lamp according to the present invention provides the even distribution of the plasma generated by the electromagnetic energy to induce the even radiation of the light by the emitting plasma, thereby enhancing the illumination effect. Moreover, the present invention shortens both of the initial lighting time and the relighting time, thereby enhancing user's convenience as well as product reliance.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. An electrodeless lamp comprising:
a transparent bulb portion forming a filling space inside to be charged with a gas-fill generating plasma by electromagnetic energy;
a stem portion extending from the bulb portion to a predetermined length to become a rotational shaft of the bulb portion; and
a protruding portion protruding from an inner circumference of the bulb portion.

2. The electrodeless lamp of claim 1, wherein the protruding portion comprises a pair of protrusions protruding from the inner circumference of the bulb portion.

3. The electrodeless lamp of claim 1, wherein the protruding portion comprises at least two protrusions protruding from the inner circumference of the bulb portion.

4. The electrodeless lamp of claim 3, wherein the protrusions are vertical to an axis extending from the same axis of the stem portion and lie in the same line on the inner circumference forming a greatest circle.

5. The electrodeless lamp of claim 4, wherein the protrusions are provided by pairs.

6. The electrodeless lamp of claim 1, wherein the protruding portion is formed like a ring figure protruding from the inner circumference of the bulb portion with uniform width and height.

7. The electrodeless lamp of claim 6, wherein the ring figure lies vertical to an axis extending from the same axis of the stem portion.

8. The electrodeless lamp of claim 1, wherein the bulb portion has a spherical figure and is uniform in thickness.

9. The electrodeless lamp of claim 1, wherein the bulb portion has an oval figure and is uniform in thickness.

10. The electrodeless lamp of claim 9, wherein a long axis of the oval bulb portion lies in the same line where the stem portion lies.

11. The electrodeless lamp of claim 1, wherein the protruding portion comprises a pair of protrusions protruding to confront each other to lie on a vertical line to an axis extending from the same axis of the stem portion.

12. The electrodeless lamp of claim 1, wherein a ratio (L1/L2) of a length (L1) between ends of the protrusions over an inside diameter (L2) of the bulb portion is 1/1.3.

13. The electrodeless lamp of claim 11, wherein each width of the protrusions is L2/8˜L2/6 for the inside diameter (L2) of the bulb portion.

14. The electrodeless lamp of claim 1, wherein the protruding portion is formed of the same material of the bulb portion.

15. An electrodeless lamp comprising:
a transparent bulb portion forming a filling space inside to be charged with a gas-fill generating plasma by electromagnetic energy;
a stem portion extending from the bulb portion to a predetermined length to become a rotational shaft of the bulb portion; and
a pair of protrusions lying in the same line on an inner circumference having a greatest diameter of the bulb portion vertical to an axis extending from the same axis of the stem portion.
